(19) United States
(12) Patent Application Publication
(10) Pub. No.: US 2017/0187856 A1
(43) Pub. Date: Jun. 29, 2017

(54) COATING UNIT AND ELECTRONIC DEVICE HAVING SAME

(71) Applicant: Samsung Electronics Co., Ltd, Gyeonggi-do (KR)

(72) Inventors: Wook Tae Kim, Gyeonggi-do (KR); Dong Soo Jung, Seoul (KR); In Gi Kim, Gyeonggi-do (KR); Seon Mi Park, Gyeonggi-do (KR); Gyu Ha Jo, Seoul (KR)

(21) Appl. No.: 15/508,903

(22) PCT Filed: Jul. 28, 2015
(86) PCT No.: PCT/KR2015/007865

§ 371 Date: Mar. 3, 2017

(30) Foreign Application Priority Data
Sep. 3, 2014 (KR) 10-2014-0116874

(51) Int. Cl. H04M 1/18; H04M 1/02; H04B 1/3888; B05D 7/00

(52) U.S. Cl. CPC H04M 1/185; B05D 7/52; H04M 1/0266; H04B 1/3888

(57) ABSTRACT

Disclosed herein is an electronic apparatus to allow a window to have an anti-scratch and anti-shock protection by allowing a coating unit including a coating layer having a high hardness and a coating layer having a low hardness, to be coated on an upper portion of the window. An electronic apparatus includes a display module, a window disposed on an upper portion of the display module to protect the display module, and a coating unit coated on an upper portion of the window to have a hardness to prevent the window from being damaged, wherein the coating unit comprises a first coating layer coated on the upper portion of the window and a second coating layer coated on an upper portion of the first coating layer to have a high hardness to prevent the window from being scratched, wherein the first coating layer is coated to have a relatively lower hardness than the second coating layer to absorb a shock applied to the window.

### TECHNICAL FIELD

Embodiments of the present disclosure relate to a coating unit coated on an upper portion of a window, which protects a display panel, to prevent the window from being damaged, and an electronic apparatus having the same.

### BACKGROUND ART

As for a display panel (hereinafter referred to panel), such as a liquid crystal display (LCD), a plasma display panel (PDP) or a light emitting diode (LED), a window is installed in a front surface of the panel, which outputs an image, to protect the panel and hide an edge of the panel.

The window may be formed of a glass or a ceramic that is a transparent material, and have a property of optical transparency.

Since the window is formed of a glass or a ceramic material, the window may be easily damaged when a shock is applied to the window from the outside, and thus a coating layer may be coated on an upper portion of the window to prevent the window from being damaged.

Since the coating layer coated on the upper portion of the window is a part where a user directly touches, the coating layer may be coated to have a high hardness to prevent the window from being scratched by scarping.

Since a coating layer having a high hardness is coated on the upper portion of the window, it may be prevented that the scratch is generated on the window but there may be a problem that the window is easily damaged when a shock is vertically applied to the upper portion of the window.

### DISCLOSURE

### Technical Problem

Therefore, it is an aspect of the present disclosure to provide an electronic apparatus to allow a window to have an anti-scratch and anti-shock protection by allowing a coating unit including a coating layer having a high hardness and a coating layer having a low hardness, to be coated on an upper portion of the window.

### Technical Solution

In accordance with one aspect of the present disclosure, an electronic apparatus includes a display module, a window disposed on an upper portion of the display module to protect the display module, and a coating unit coated on an upper portion of the window to have a hardness to prevent the window from being damaged, wherein the coating unit comprises a first coating layer coated on the upper portion of the window and a second coating layer coated on an upper portion of the first coating layer to have a high hardness to prevent the window from being scratched, wherein the first coating layer is coated to have a relatively lower hardness than the second coating layer to absorb a shock applied to the window.

The coating unit may be coated by using one method of a Diamond-like Carbon (DLC) coating, a metal oxide coating, and a ceramic coating.

The first coating layer may have a hardness of from 1 GPa to 10 GPa and a relatively larger thickness than the second coating layer.

The second coating layer may have a hardness of 10 GPa or more and a relatively less thickness than the first coating layer.

The coating unit may be provided such that a plurality of coating layers comprising the first coating layer and the second coating layer is stacked.

The window may be formed of one of a glass and a ceramic, which are a transparent material.

In accordance with another aspect of the present invention, an electronic apparatus includes a display module, a window attached on an upper portion of the display module to protect the display module, and a coating unit coated on an upper portion of the window to prevent the window from being damaged and provided with a plurality of coating layers having a different hardness, wherein among the plurality of coating layers, a coating layer having a relatively low hardness is coated adjacent to the window.

The coating unit may be coated by using one method of a Diamond-like Carbon (DLC) coating, a metal oxide coating, and a ceramic coating.

The coating unit may comprise a first coating layer coated adjacent to the window and a second coating layer coated on an upper portion of the first coating layer.

The first coating layer may have a hardness of from 1 GPa to 10 GPa and a relatively larger thickness than the second coating layer to absorb a shock applied to the window.

The second coating layer may have a hardness of 10 GPa or more and a relatively less thickness than the first coating layer to prevent the window from being scratched.

the coating unit may be provided such that a plurality of coating layers comprising the first coating layer and the second coating layer is stacked.

In accordance with another aspect of the present invention, a coating unit coated on an upper portion of a window, which protects a display module, to prevent the window from being damaged, the coating unit includes a first coating layer coated on the upper portion of the window, a second coating layer coated on an upper portion of the first layer to have a high hardness to prevent the window from being scratched, wherein the first coating layer is coated to have a relatively less hardness than the second coating layer to absorb a shock applied to the window.

The first coating layer and the second coating layer are coated by using one method of a Diamond-like Carbon (DLC) coating, a metal oxide coating, and a ceramic coating.

The first coating layer may have a hardness of from 1 GPa to 10 GPa and a relatively larger thickness than the second coating layer.

The second coating layer may have a hardness of 10 GPa or more and a relatively less thickness than the first coating layer.

### Advantageous Effects

In accordance with one aspect of the present disclosure, it may be possible to provide a window having an anti-scratch and anti-shock protection by allowing a coating unit including a coating layer having a high hardness and a coating layer having a low hardness, to be coated on an upper portion of the window.

### DESCRIPTION OF DRAWINGS

These and/or other aspects of the present disclosure will become apparent and more readily appreciated from the following description of the embodiments, taken in conjunction with the accompanying drawings of which:

FIG. 1 is a perspective view illustrating a front side of an electronic apparatus in accordance with one embodiment of the present invention;

FIG. 2 is a perspective view illustrating a rear side of the electronic apparatus in accordance with one embodiment of the present invention;

FIG. 3 is an exploded-perspective view illustrating the electronic apparatus in accordance with one embodiment of the present invention;

FIG. 4 is a view schematically illustrating a display module of the electronic apparatus in accordance with one embodiment of the present invention;

FIG. 5 is a cross-sectional view schematically illustrating a case in which a coating unit, an adhesive layer, and an outer coating layer are coated on an upper portion of a window in accordance with one embodiment of the present invention;

FIG. 6 is a cross-sectional view schematically illustrating a case in which the coating unit is coated on the upper portion of the window in accordance with one embodiment of the present invention;

FIG. 7 is a cross-sectional view schematically illustrating a case in which the coating unit absorbs a shock when the shock is applied to the window shown in FIG. 6;

FIG. 8 is a graph illustrating a result of a shock test in a case in which the coating unit is coated on the upper portion of the window and the coating unit is not coated on the upper portion of the window in accordance with one embodiment of the present invention;

FIG. 9 is a cross-sectional view schematically illustrating a case in which a plurality of coating layers including a first coating layer and a second coating layer and being coated on the upper portion of the window is stacked in accordance with one embodiment of the present invention.

### BEST MODE

Reference will now be made in detail to the embodiments of the present disclosure, examples of which are illustrated in the accompanying drawings, wherein like reference numerals refer to like elements throughout.

For the convenience of the description, a mobile electronic apparatus will be descried as an example of an electronic apparatus.

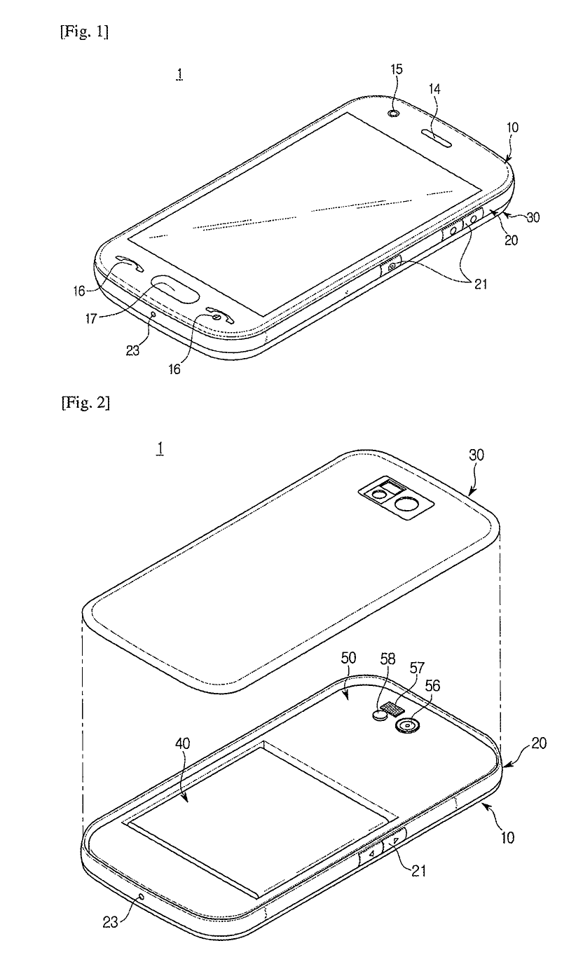

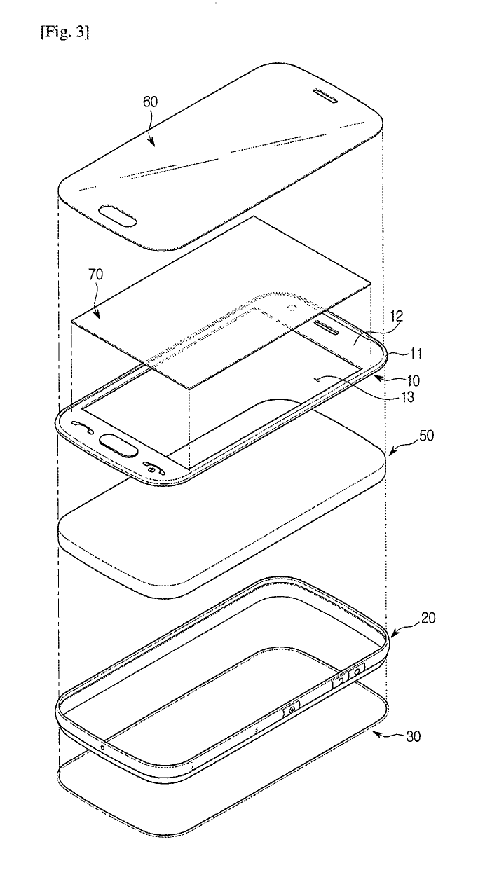

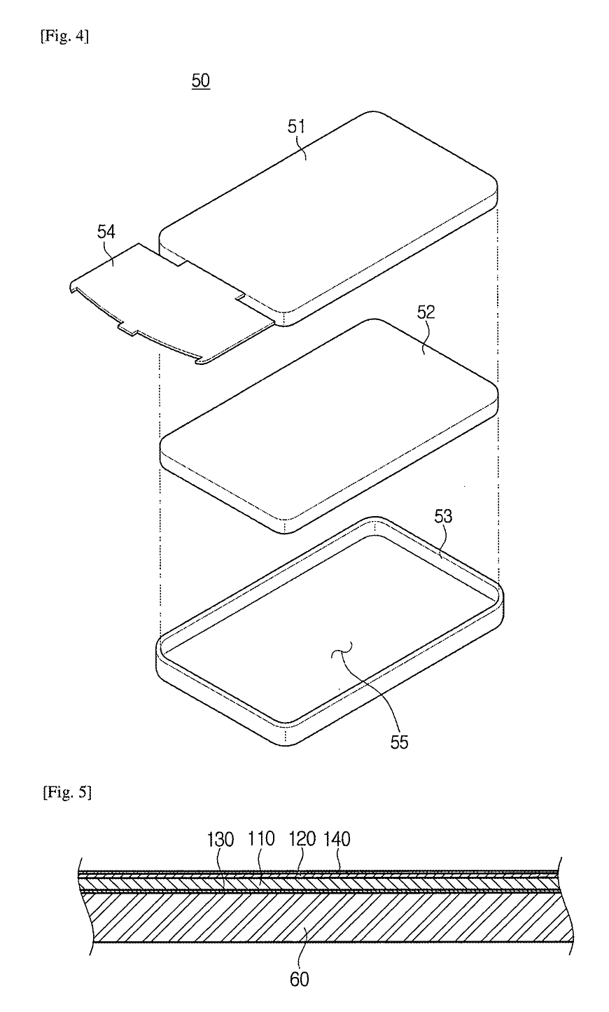

FIG. 1 is a perspective view illustrating a front side of an electronic apparatus in accordance with one embodiment of the present disclosure, FIG. 2 is a perspective view illustrating a rear side of the electronic apparatus in accordance with one embodiment of the present disclosure, FIG. 3 is an exploded-perspective view illustrating the electronic apparatus in accordance with one embodiment of the present disclosure, and FIG. 4 is a view schematically illustrating a display module of the electronic apparatus in accordance with one embodiment of the present disclosure.

As illustrated in FIGS. 1 to 4, an electronic apparatus 1 may have a bar shape.

However, the shape of the electronic apparatus 1 is not limited to the bar shape and thus a variety of shapes, e.g. a slid type, a folder type, a swing type and a swivel type, may be applied to the shape of the electronic apparatus 1.

A body may include a front case 10, a rear case 20, and a battery cover 30. A variety of electronic components may be embedded in a space between the front case 10 and the rear case 20.

Although not shown in the drawings, at least one middle case may be additionally disposed between the front case 10 and the rear case 20.

The front case 10, the rear case 20, and the battery cover 30 may be formed by an injection molding using a resin, or may be formed to have a metal material, e.g. a stainless still (STS), an aluminum (Al) and a titanium (Ti).

The front case 10 may include a bezel part 11 forming an edge, a setting part 12 in which a window 60 described later is placed, and an opening part 13 allowing an image that is formed by a display module 50 described later to be exposed to the outside.

A sound output unit 14 outputting a sound, a front camera 15, and a first operator 12 among a user input, and an interface 17 may be disposed on the setting part 12.

Although the drawings illustrate that the setting part 12 is formed in the front case 10, the setting part 12 may be formed separately from the front case 10.

The rear case 20 may be disposed in a lower side of the front case 10 and in the rear case 20, a second operator 21 among the user input and a microphone 23 may be disposed.

The user input 16 and 21 may be operated to receive an input of a command for controlling an operation of the electronic apparatus 1 and may be provided with a plurality of operators including the first operator 16 and the second operator 21.

The plurality of operators may employ any technology as long as having a tactile manner that is configured to allow a user to operate by applying a tactile sense.

A content, which is input by the first operator 16 and the second operator 21, may be set to be various.

For example, the first operator 16 may receive an input of a command, e. g, starting, ending and scrolling, and the second operator 21 may receive an input of a command, e. g., regulating a volume of a sound output from a sound output unit 14 or converting into a touch recognition mode of the display module 50.

The display module 50 may form a touch screen together with a touch sensor 70 described later, and the touch screen may be an example of the user input.

A power supplier 40 configured to supply the power to the electronic apparatus 1 may be mounted to the body of the electronic apparatus 1, and the power supplier 40 may be embedded in the body of the electronic apparatus 1 or detachably mounted to the outside of the electronic apparatus 1 in a direct manner.

An antenna (not shown) may be mounted to the body of the electronic apparatus 1 for calling and also an antenna may be additionally disposed on the body of the electronic apparatus 1 for receiving a broadcast signal.

An antenna device may be disposed on the body of the electronic apparatus 1 to implement a Near Field Communication (NFC).

The display module 50, the window 60 and the touch sensor 70 may be placed in the electronic apparatus 1.

The display module 50 may include a display module 51, a backlight unit 53 and a module fixing body 55.

The display panel 51 may function of converting image data, which is input from a controller (not shown) of the electronic apparatus 1 via a flexible printed circuit board (FPCB) 57, into an analog signal and displaying the analog signal, and the display panel 51 may be implemented by a Liquid Crystal Display (LCD).

A back light unit 53 may be mounted on a bottom of the display panel 51 to supply light to the display panel 51.

That is, the display panel 51 may display an image by adjusting a color and an amount of transmitted light that is incident light from the backlight unit 53.

The module fixing body 55 may fix the display panel 51 and the backlight unit 53. An accommodation space 59 in which the display panel 51 and the backlight unit 53 are placed may be provided in the module fixing body 55.

A rear camera 56 may be provided on a rear surface of the display module 50. The rear camera 56 may have a capturing direction that is practically opposite to the front camera 15 and have a pixel different from the front camera 15.

For example, the front camera 15 may have a low pixel so that there is no difficulty in capturing a user's face and transmitting the image to a receiver during a videotelephony, but the rear camera 56 may have a high pixel since there are many cases in which the rear camera 50 does not immediately transmit the captured object after capturing a general object.

A flash 57 and a mirror 58 may be additionally provided adjacent to the rear camera 56. The flash 57 may shine light to an object when capturing the object with the rear camera 56. The mirror 58 may be used for a user to illuminate his or her own face when capturing himself or herself with the rear camera 56.

The window 60 may be disposed on an upper portion of the display module 50 to protect the display module 50 and formed of a material having the optical transparency allowing light to pass through, e.g., a glass or a ceramic that is a transparent material.

The touch sensor 70 may be mounted to the window 60 to detect a touch input. The touch sensor 70 may be formed of a material having the optical transparency and configured to convert a variation of a pressure, a voltage, and a capacitance, which is generated in a certain part of the window 60, into an electrical input signal.

The touch sensor 70 may be a capacitance sensor, but is not limited thereto.

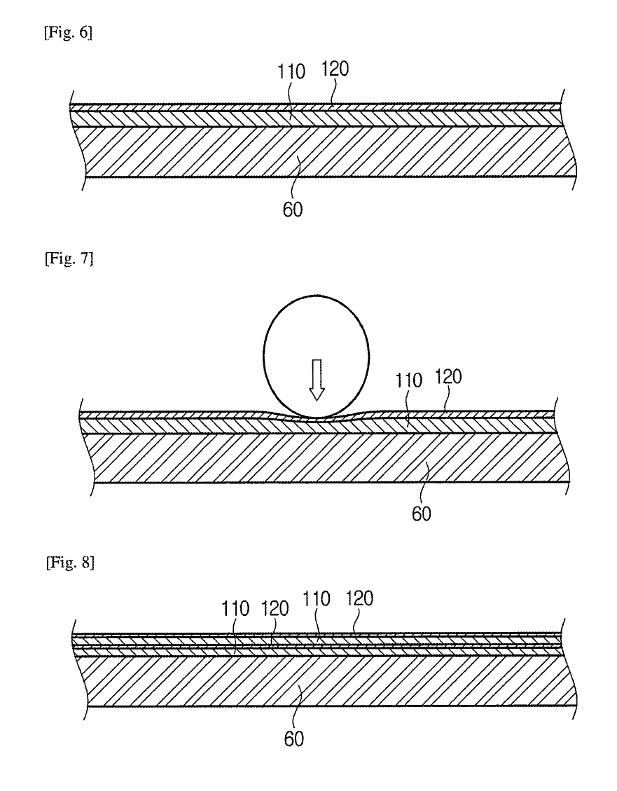

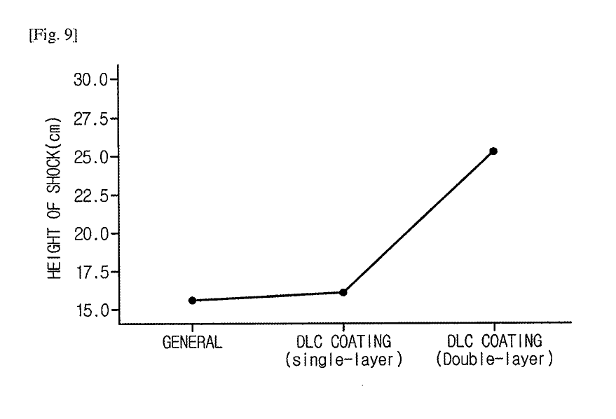

FIG. 5 is a cross-sectional view schematically illustrating a case in which a coating unit, an adhesive layer, and an outer coating layer are coated on an upper portion of a window in accordance with one embodiment of the present disclosure, FIG. 6 is a cross-sectional view schematically illustrating a case in which the coating unit is coated on the upper portion of the window in accordance with one embodiment of the present disclosure, FIG. 7 is a cross-sectional view schematically illustrating a case in which the coating unit absorbs a shock when the shock is applied to the window shown in FIG. 6, FIG. 8 is a graph illustrating a result of a shock test in a case in which the coating unit is coated on the upper portion of the window and the coating unit is not coated on the upper portion of the window in accordance with one embodiment of the present disclosure, and FIG. 9 is a cross-sectional view schematically illustrating a case in which a plurality of coating layers including a first coating layer and a second coating layer and being coated on the upper portion of the window is stacked in accordance with one embodiment of the present disclosure.

As illustrated in FIG. 5, a coating unit 100, an adhesive layer 130 and an outer coating layer 140 may be coated on the upper portion of the window 60.

The coating unit 100 may include a first coating layer 110 and a second coating layer 120. The adhesive layer 130 may be coated between the first coating layer 110 and the window 60 to improve the adhesive force of the first coating layer 110 and the window 60. The outer coating layer 140, such as an anti-fingerprint layer for preventing fingerprints or an anti-reflection layer for preventing reflection of light, may be coated on an upper portion of the second coating layer 120.

As illustrated in FIG. 6, the coating unit 100 may be coated on the upper portion of the window 60 to prevent the window 60 from being damaged.

The coating unit 100 may be configured to have the hardness and may include the first coating layer 110 coated on the upper portion of the window 60 and the second coating layer 120 coated on an upper portion of the first coating layer 110.

The coating unit 100 may be coated by using a coating method such as a Diamond-like Carbon (DLC) coating, a metal oxide coating, and a ceramic coating which are to allow the coating unit 100 to have the hardness.

According to one embodiment, for the convenience of the description, the coating unit 100 will be described to be coated by using the DLC coating.

The DLC coating is an amorphous carbon-based new material and a thin film-shaped material created by the collision to the substrate by electrically accelerating carbon ions or activated hydrocarbon molecules in the plasma. The DLC coating has physical properties, e.g., hardness, corrosion resistance and wear resistance, which is similar to diamond.

The first coating layer 110 may be coated on the upper portion of the window 60 to be adjacent to the window 60 and configured to have a hardness of from 1 GPa to 10 GPa.

The first coating layer 110 may have a relatively lower hardness than the second coating layer 120 and thus as illustrated in FIG. 7, when a shock is applied to the window 60 in a vertical direction, the coating unit 100 may prevent the window 60 from being damaged by absorbing the shock.

The first coating layer 110 may have a relatively lower hardness than the second coating layer 120 and a relatively larger thickness than the second coating layer 120 to effectively absorb a shock that is applied to the window 60.

The second coating layer 120 may be coated on the upper portion of the first coating layer 110 and configured to have a hardness of 10 GPa or more.

The second coating layer 120 may have a relatively higher hardness than the first coating layer 110 and configured to prevent the window 60 from being scratched.

Since the second coating layer 120 has a high hardness, it may be prevented that a scratch is generated in the window 60 when a shock is applied to a side surface of the window 60, wherein the shock is strong enough to make a scratch on the window 60.

Since the coating unit 100 including the first coating layer 110 and the second coating layer 120 is coated on the upper portion of the window 60, wherein the coating unit 100 is configured to prevent the window 60 from being damaged by a shock applied to the window 60, the second coating layer 120 may prevent a scratch from being generated in the window 60 when the shock, which is strong enough to make a scratch on the window 60, is applied to the side surface of the window 60, and the first coating layer 110 may prevent the window 60 from being damaged by absorbing a shock when the shock is applied to the window 60 in the vertical direction.

FIG. 8 is a graph illustrating a result of a shock test in a case in which the coating unit 100 is not coated on the upper portion of the window 60, the coating unit 100 including a single layer having a high hardness is coated on the upper portion of the window 60, and the coating unit 100 including the second coating layer 120 having a high hardness and the first coating layer 110 having a relatively lower hardness than the second coating layer 120 is coated on the upper portion of the window 60.

As illustrated in FIG. 8, the test is performed in a state in which the same object vertically drops on the upper portion of the window 60. In a state in which the window 60 is a general window 60 on which the coating unit 100 is not coated, when the object drops from a height of an approximately 15.1 cm, the window 60 is damaged. In a state in which the coating unit 100 including a single layer having a high hardness is coated on the upper portion of the window 60, when the object drops from a height of an approximately 16.1 cm, the window 60 is damaged. In a state in which the coating unit 100 including the second coating layer 120 having a high hardness and the first coating layer 110 having a relatively lower hardness than the second coating layer 120 is coated on the upper portion of the window 60, when the object drops from a height of an approximately 25.3 cm, the window 60 is damaged.

As shown in the result, when the coating unit 100 including the first coating layer 110 and the second coating layer 120 is coated on the upper portion of the window 60, it may be possible to maximally prevent the window 60 from being damaged caused by the shock vertically applied to the window 60, and it may be possible to effectively prevent that the scratch is generated in the window 60 since the second coating layer 120 having the high hardness is disposed on the upper portion of the first coating layer 110.

As illustrated in FIG. 9, the coating unit 100 may be provided such that a plurality of coating layers 110 and 120 including the first coating layer 110 and the second coating layer 120 is stacked. When the plurality of coating layers 110 and 120 is stacked, an entire height of the coating unit 100 may be similar to an entire height of the coating unit 100 configured with a single first coating layer 110 and a single second coating layer 120.

Although the drawings illustrate a case in which the coating layer 110 and 120 is stacked with two layers, but is not limited thereto.

Although a few embodiments of the present disclosure have been shown and described, it would be appreciated by those skilled in the art that changes may be made in these embodiments without departing from the principles and spirit of the disclosure, the scope of which is defined in the claims and their equivalents.

1. An electronic apparatus comprising:
a display module;
a window disposed on an upper portion of the display module to protect the display module; and
a coating unit coated on an upper portion of the window to have a hardness to prevent the window from being damaged, wherein the coating unit comprises:
a first coating layer coated on the upper portion of the window, and
a second coating layer coated on an upper portion of the first coating layer to have a high hardness to prevent the window from being scratched,
wherein the first coating layer is coated to have a relatively lower hardness than the second coating layer to absorb a shock applied to the window.

2. The electronic apparatus of claim 1, wherein the coating unit is coated by using one method of a diamond-like carbon (DLC) coating, a metal oxide coating, and a ceramic coating.

3. The electronic apparatus of claim 1, wherein the first coating layer has a hardness of from 1 GPa to 10 GPa and a relatively larger thickness than the second coating layer.

4. The electronic apparatus of claim 3, wherein the second coating layer has a hardness of 10 GPa or more and a relatively less thickness than the first coating layer.

5. The electronic apparatus of claim 1, wherein the coating unit is provided such that a plurality of coating layers comprising the first coating layer and the second coating layer is stacked.

6. The electronic apparatus of claim 1, wherein the window is formed of one of: a glass or a ceramic, which is a transparent material.

7. An electronic apparatus comprising:
a display module;
a window attached on an upper portion of the display module to protect the display module; and
a coating unit coated on an upper portion of the window to prevent the window from being damaged and provided with a plurality of coating layers having a different hardness,
wherein, among the plurality of coating layers, a coating layer having a relatively low hardness is coated adjacent to the window.

8. The electronic apparatus of claim 7, wherein the coating unit is coated by using one method of: a diamond-like carbon (DLC) coating, a metal oxide coating, or a ceramic coating.

9. The electronic apparatus of claim 8, wherein the coating unit comprises a first coating layer coated adjacent to the window and a second coating layer coated on an upper portion of the first coating layer.

10. The electronic apparatus of claim 9, wherein the first coating layer has a hardness of from 1 GPa to 10 GPa and a relatively larger thickness than the second coating layer to absorb a shock applied to the window.

11. The electronic apparatus of claim 10, wherein the second coating layer has a hardness of 10 GPa or more and a relatively less thickness than the first coating layer to prevent the window from being scratched.

12. The electronic apparatus of claim 11, wherein the coating unit is provided such that a plurality of coating layers comprising the first coating layer and the second coating layer is stacked.

13. A coating unit coated on an upper portion of a window, which protects a display module to prevent the window from being damaged, the coating unit comprising:
a first coating layer coated on the upper portion of the window;
a second coating layer coated on an upper portion of the first layer to have a high hardness to prevent the window from being scratched,
wherein the first coating layer is coated to have a relatively less hardness than the second coating layer to absorb a shock applied to the window.

14. The coating unit of claim 13, wherein the first coating layer and the second coating layer are coated by using one method of: a diamond-like carbon (DLC) coating, a metal oxide coating, or a ceramic coating.

15. The coating unit of claim 14, wherein the first coating layer has a hardness of from 1 GPa to 10 GPa and a relatively larger thickness than the second coating layer.

16. The coating unit of claim 15, wherein the second coating layer has a hardness of 10 GPa or more and a relatively less thickness than the first coating layer.
